(19) United States
(12) Patent Application Publication
(10) Pub. No.: US 2006/0252011 A1
(43) Pub. Date: Nov. 9, 2006

(54) Method and device for inhibiting nail biting

(76) Inventor: Michael Etessami, Potomac, MD (US)

Correspondence Address: DENNISON, SCHULTZ & MACDONALD, 1727 KING STREET, SUITE 105, ALEXANDRIA, VA, 22314, US

(21) Appl. No.: 11/429,321

(22) Filed: May 8, 2006

Related U.S. Application Data
(60) Provisional application No. 60/678,807, filed on May 9, 2005.

(51) Int. Cl. A61C 5/00

(52) U.S. Cl. 433/215; 433/6

(57) ABSTRACT

A method for inhibiting nail biting by a patient utilizing an occlusal guard formed by forming a positive impression of the teeth of at least one of a patient's upper arch and lower arch, and adding to the impression about 1 mm of molding material corresponding to the incisal areas of the teeth, forming thereby an adjusted impression. A sheet of plastic material of thickness about 1 mm is molded to the adjusted impression to form a U-shaped occlusal guard with full coverage around all crowns of the teeth of the upper or lower arch, the guard including indentations corresponding to the position of natural teeth. The guard is disposed over the teeth of at least one of the upper and lower arch of a patient, and in place results in a visible opening around the incisal areas.

This application claims the benefit of U.S. Provisional Application 60/678,807 filed May 9, 2005.

### BACKGROUND OF THE INVENTION

The invention relates to the field of orthodontic appliances, particularly an appliance which inhibits nail biting.

Nail biting is a harmful and disfiguring habit, and a number of over-the-counter remedies are available to break the habit. Most commonly used are solutions for coating the nails which taste bad and bandages, but these have not been found to be successful. In addition, hypnosis has been attempted on younger children.

Positive reinforcement methods generally yield better results than negative reinforcement methods, but have had little or no effect in very young patients and older patients.

Other attempted remedies include the tongue shield proposed in U.S. Pat. No. 4,976,275, which prevents the tongue from contacting a fingernail or fingertip when placed in the mouth.

Orthodontic appliances which cover the upper or lower teeth are also well known. Such appliances are sold as mouth guards for athletics, and can also be custom molded to the teeth to align the teeth or to prevent grinding. The devices for aligning the teeth are known as tooth positioners, and are generally U-shaped devices, conforming to the shape of the dental arches and formed of a soft, flexible or resilient material. A trough is formed along the generally U-shaped configuration of a tooth positioner containing multiple depressions, each depression being negatively formed to contact and accept a corresponding tooth. When placed in the patient's mouth, the tooth positioner typically spans and accepts all of the teeth of an upper or lower arch of the patient and in doing so typically covers the entire crown of the teeth.

In the past, tooth positioners were formed by first creating a mold and then casting thermosetting or other materials in the mold that required heat, pressure and time to cure. The result was a positive impression of the patient's mouth, and a technician would reposition the teeth of the impression to a desired configuration. A sheet of material would then be molded to the adjusted impression.

More recently, cameras have been used to generate a “virtual” impression of the teeth, which would then be used to form the appliances. Such tooth positioners have been sold under the trademark “Invisalign” by Align Technologies, Inc.

### SUMMARY OF THE INVENTION

It is an object of the invention to provide a method for inhibiting nail biting utilizing a device similar to a tooth positioner.

It is another object of the invention to provide an orthodontic device which separates the upper and lower teeth sufficiently to prevent effective biting of fingernails.

It is a further object of the invention to provide a method for forming an appliance to achieve the above objects.

To achieve these and other objects, the invention is directed to a method for inhibiting nail biting comprising:

forming a positive impression of at least one of a patient's upper arch and lower arch;

adding to the impression about 1 mm of molding material corresponding to incisal areas of the teeth, forming thereby an adjusted impression;

molding to the adjusted impression a sheet of plastic material of thickness about 1 mm to form a U-shaped occlusal guard with full coverage around all crowns of the teeth of the upper or lower arch, the guard including indentations corresponding to the position of natural teeth; and

disposing the guard over the upper or lower arch of a patient, resulting in a visible opening between the teeth and the guard around the incisal areas of the teeth.

The operation of the invention is thus the fabrication of an appliance that does not allow for any tooth movement, but which can create a small space between the incisal edges of the teeth, especially teeth 6, 7, 8, 9, 10 and 11, which constitute the upper sexdant (upper front teeth) used for incising food or other material such as nail biting.

Due to the visible opening around the incisal areas, it is impossible for the patient bring the upper and lower teeth together to bite a nail if at least one of the upper and lower guards is in place.

### BRIEF DESCRIPTION OF THE DRAWINGS

FIG. 1 is a perspective view of an impression of teeth;

FIG. 2 is a perspective view of the impression of FIG. 1, adjusted according to the invention;

FIG. 3 is a perspective view of an appliance formed from the impression of FIG. 2; and

FIG. 4 is a perspective view of the appliance of FIG. 3 placed on the teeth.

### DESCRIPTION OF THE PREFERRED EMBODIMENTS

The basic principle in the design of this appliance is providing a device that meets the following standards:

a) stable enough that it cannot be dislodged during speech or sleep;

b) non-intrusive, so that within a day or two the patient can resume normal speech patterns;

c) removable, so that good oral hygiene can be maintained, and patient can eat and drink normally;

d) sufficiently invisible to a layman's eye;

e) over time, the appliance will not only act as a deterrent to the habit, but also it will gradually help establish a new behavior pattern through positive reinforcement, much like a reminder and or a “crutch” to help overcome the habit.

The design of the appliance is best established taking into account the following criteria:

a) A thorough radiographic survey of the mouth is performed using a panoramic radiograph to check for any pathology or anomalies, and showing the full length of the roots and crowns. A cephalometric x-ray is used for children under 18 to address issues related to children with class III tendency, who have a vertical growth pattern. This is not an issue for adults since 99% of mandibular and maxillary growth is completed by age 18. A panoramic x-ray is used for all patients.

b) A thorough examination of the occlusion is performed to determine the overbite, overjet and lateral excursive movements.

c) The position and anatomy of the incisors and canines is determined.

d) The thickness of the nail, placement of the digit and the vector of force through which the nail biting occurs is determined.

The following method is best used to fabricate the appliance:

a) For permanent dentition, after diagnostic work up, impressions of the upper and lower teeth are made and a wax bite of the centric occlusion is made.

b) A cast die is made from the impressions;

c) one mm of space is added to the six anterior upper teeth either using sticky wax or by computer design.

d) A new impression of the redesigned model will is made.

e) Using thin plastic material the appliance is fabricated. Preferably, the appliance is fabricated for the upper arch and a passive appliance is made for the lower arch.

The occlusion will not change since the teeth will not super erupt due to full engagement on buccal, lingual and interproximal aspects.

Once the appliances are placed in the mouth there will be approximately 0.5 mm of space between the incisal edges of the upper anterior teeth and the lower anterior teeth, whereby the incisal capability of the anterior teeth will be diminished considerably, making it impossible to cut or incise through fingernails, which would normally require full masticatory forces to break or chew off the nails. The appliances are clear and virtually invisible, and won't affect speech or aesthetics. They will however need to be removed while eating and performing oral hygiene.

For children, if there is a loose primary tooth or if an edentulous area is present from a recent exfoliation of a primary tooth, then the area will be built up by wax on the model prior to construction of the appliance to compensate.

The plastic material used is similar to those used in making aciform, an acrylic sheet, Raintree Essix. These acrylic sheets are FDA approved for use in the mouth, non-allergenic and bio-compatible, and have been used for many years without harm. These sheets start about 1 mm in thickness, but the thickness is reduced to about 0.5 mm after the sheet is heated and molded.

Methods for casting the teeth are well known, and will not be discussed here. However, the invention is equally applicable to physical casting and to “virtual” casting in which a photograph is used to generate a computer image of the teeth which is used to form the appliance after adding about 1 mm of additional “tooth” to the incisal areas.

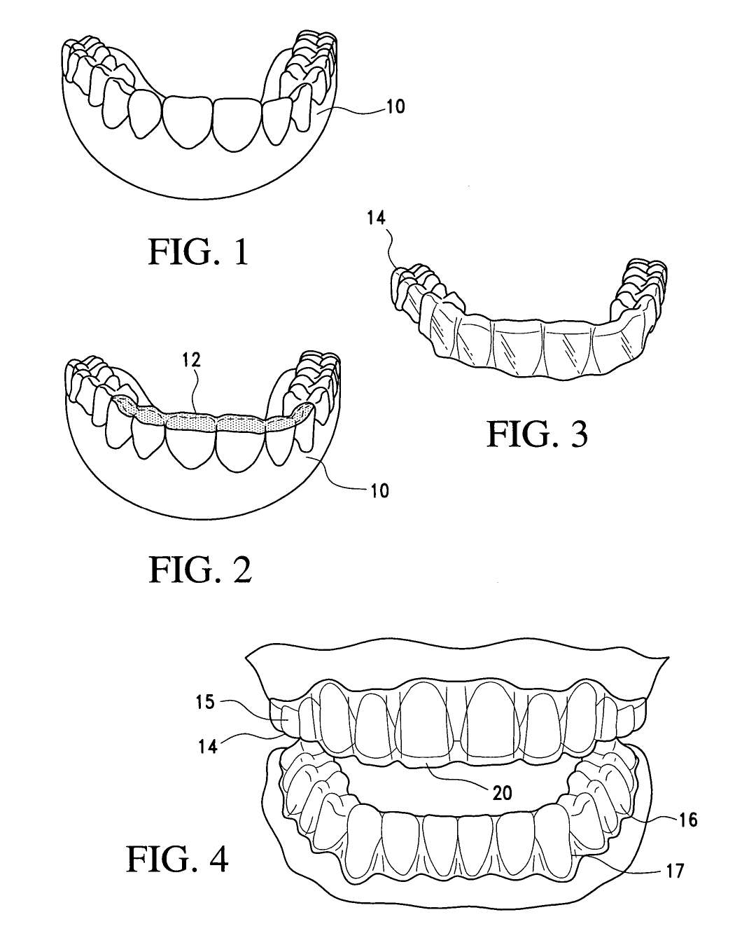

FIG. 1 shows an impression 10 of natural adult teeth. In FIG. 2, approximately 1 mm of wax 12 has been added to the incisal areas of six teeth.

FIG. 3 shows an appliance 14 which has been molded from the impression 10 with additional wax areas 12.

FIG. 4 shows the placement of the appliance 14 in the mouth of a patient on the upper arch 15, with a second uncorrected appliance 16 placed on the lower arch 17. Approximately 0.5 mm of space 20 is present between the upper appliance and the teeth, making it virtually impossible to bite through a fingernail.

What is claimed is:

1. A method for inhibiting nail biting by a patient comprising the steps of:
forming a positive impression of the teeth of at least one of a patient's upper arch and lower arch;
adding to the impression about 1 mm of molding material corresponding to the incisal areas of the teeth, forming thereby an adjusted impression;
molding to the adjusted impression a sheet of plastic material of thickness about 1 mm to form a U-shaped occlusal guard with full coverage around all crowns of the teeth of the upper or lower arch, the guard including indentations corresponding to the position of natural teeth; and
disposing the guard over the upper or lower arch of a patient, resulting in a visible opening between the teeth and the guard around the incisal areas of the teeth.

2. The method of claim 1, wherein a guard is disposed over the teeth of at least the upper arch.

3. The method of claim 1, wherein the guard of the lower arch is formed from an impression which has not been adjusted.

4. The method of claim 1, wherein the plastic material is an acrylic.

5. The method of claim 4, wherein the acrylic is in the form of a sheet having a thickness of about 1 mm before molding.

6. The method of claim 1, wherein the positive impression is formed by taking a physical impression of the mouth of the patient.

7. The method of claim 1, wherein the positive impression is a computer generated impression formed by taking photographs of the mouth of the patient.

8. The method of claim 1, wherein the incisal areas comprise teeth 6 to 11 of the upper sexdant.

9. A method of forming an occlusal guard for inhibiting nail biting, comprising the steps of:
forming a positive impression of the teeth of at least one of a patient's upper arch and lower arch;
adding to the impression about 1 mm of molding material corresponding to the incisal areas of the teeth, forming thereby an adjusted impression; and
molding to the adjusted impression a sheet of plastic material of thickness about 1 mm to form a U-shaped occlusal guard with full coverage around all crowns of the teeth of the upper or lower arch, the guard including indentations corresponding to the position of natural teeth.

10. The method of claim 9, wherein the plastic material is an acrylic.

11. The method of claim 10, wherein the acrylic is in the form of a sheet having a thickness of about 1 mm before molding.

12. The method of claim 9, wherein the positive impression is formed by taking a physical impression of the mouth of the patient.

13. The method of claim 9, wherein the positive impression is a computer generated impression formed by taking photographs of the mouth of the patient.

14. The method of claim 9, wherein the incisal areas comprise teeth 6 to 11 of the upper sexdant.

15. An occlusal guard formed by adjusting a positive impression of natural teeth by adding about 1 mm of additional material to the incisal areas, and thereafter molding to the positive impression a plastic material to form a U-shaped occlusal guard with full coverage around all crowns of the teeth of the upper or lower arch, the guard including indentations corresponding to the position of natural teeth.

16. The guard of claim 15, wherein the plastic is an acrylic.
